(19) United States
(12) Patent Application Publication
(10) Pub. No.: US 2019/0223257 A1
(43) Pub. Date: Jul. 18, 2019

(54) RELAY INDICATION METHOD AND ACCESS POINT AP

(71) Applicant: HUAWEI TECHNOLOGIES CO., LTD., SHENZHEN (CN)

(72) Inventors: Xiao HAN, Shenzhen (CN); Peter LOC, Cupertino, CA (US); Yunbo LI, Shenzhen (CN); Yuchen GUO, Shenzhen (CN); Xun ZHOU, Shenzhen (CN)

(21) Appl. No.: 16/364,124

(22) Filed: Mar. 25, 2019

Related U.S. Application Data
(63) Continuation of application No. PCT/CN2017/098585, filed on Aug. 23, 2017.

(30) Foreign Application Priority Data
Sep. 27, 2016 (CN) 201610854314.7

(51) Int. Cl. H04W 88/10; H04W 80/02; H04W 72/04; H04L 1/00

(52) U.S. Cl. CPC H04W 88/10; H04L 1/0005; H04W 72/0446; H04W 80/02

(57) ABSTRACT

Embodiments of this application provide a relay indication method and an access point (AP). The method includes: sending, by an AP, relay indication information to at least one station (STA); and further, receiving, by the AP, a reply message sent by one or more of the at least one STA. In this way, relay communication in an IoT communications system is implemented.

### CROSS-REFERENCE TO RELATED APPLICATIONS

This application is a continuation of International Application No. PCT/CN2017/098585, filed on Aug. 23, 2017, which claims priority to Chinese Patent Application No. 201610854314.7, filed on Sep. 27, 2016. The disclosures of the aforementioned applications are herein incorporated by reference in their entireties.

### TECHNICAL FIELD

Embodiments of this application relate to the field of communications technologies, and in particular, to a relay indication method and an access point AP.

### BACKGROUND

With development of a communications system, relay communication becomes increasingly important. In typical relay communication, a three-node relay channel model is used, including a source node S, a relay node R, and a destination node D; and S sends a signal to D with assistance of R.

In an existing Institute of Electrical and Electronics Engineers (IEEE) 802.11ad, the relay communication is described based on a communications system corresponding to a directional antenna, and cannot be applied to an Internet of Things (IoT) communications system (that is, a communications system corresponding to a non-directional antenna). Therefore, how to implement relay communication in the IoT communications system is a technical problem to be resolved in this application.

### SUMMARY

Embodiments of this application provide a relay indication method and an access point (AP), so as to implement relay communication in an IoT communications system.

According to a first aspect, an embodiment of this application provides a relay indication method, including:

sending, by an access point (AP), relay indication information to at least one station (STA); and

receiving, by the AP, a reply message sent by one or more of the at least one STA.

By using the relay indication method provided in the first aspect, the AP sends the relay indication information to the at least one station (STA), and further, receives the reply message sent by one or more of the at least one STA based on the relay indication information. It can be learned that relay communication in an IoT communications system is implemented.

In one embodiment, the relay indication information includes one or more of the following:

an indication about whether a relay STA is used for data transmission;

a quantity of relay STAs used for data transmission;

an identifier of the relay STA used for data transmission; or

an indication about whether a message sent by the relay STA carries a preamble.

In one embodiment, the sending, by an AP, relay indication information to at least one STA includes:

sending, by the AP, an information frame to the at least one STA, where the information frame includes the relay indication information.

In one embodiment, the relay indication information is located in a preamble, a service domain, a Media Access Control (MAC) header, or payload of the information frame.

In one embodiment, the relay indication information is located in an unused or a reusable field of the preamble, the service domain, the MAC header, or the payload of the information frame; or
the relay indication information is located in a newly added indication field of the preamble, the service domain, the MAC header, or the payload of the information frame.

In one embodiment the relay indication information is located in one of the following fields of the preamble: a field indicating a modulation and coding scheme (MCS), a field indicating a quantity of streams, or a field indicating bandwidth.

In one embodiment, the sending, by an AP, relay indication information to at least one STA includes:

sending, by the AP, the relay indication information to the at least one STA in a first time period, where the relay indication information is forwarded by a relay STA in the at least one STA in a second time period to an Internet of Things STA within a management range of the relay STA.

In one embodiment, the receiving, by the AP, a reply message sent by one or more of the at least one STA includes:

when the Internet of Things STA belongs to the at least one STA, receiving, by the AP in the second time period, the reply message sent by a STA in the at least one STA other than the relay STA and the Internet of Things STA; or
when the Internet of Things STA does not belong to the at least one STA, receiving, by the AP in the second time period, the reply message sent by a STA in the at least one STA other than the relay STA.

By using the relay indication method provided in this implementation, both uplink (UL) transmission and downlink (DL) transmission are included in a same time period, thereby implementing hybrid transmission.

In one embodiment, the method further includes:

receiving, by the AP, acknowledgement information sent by the Internet of Things STA by using the relay STA, where the acknowledgement information is used to indicate, to the AP, that the Internet of Things STA can receive a frame sent by the AP.

In one embodiment, the information frame further includes relay condition information, where the relay condition information is used to indicate a preset condition for becoming the relay STA.

In one embodiment, the preset condition includes one or more of the following:

a link condition;

a STA service condition;

a power supply condition of the STA;

a quantity of other STAs within a preset range; or

a condition under which a target STA can be connected.

By using the relay indication method provided in this implementation, the AP carries the relay condition information in the information frame, so that a STA that meets the preset condition can send the reply message to the AP on a corresponding resource, thereby improving efficiency of determining a target relay STA.

In one embodiment, the information frame further includes resource allocation indication information, and the resource allocation indication information is used to indicate, to the at least one STA, a resource used for sending the reply message.

In one embodiment, the resource allocation indication information is located in any one of the following fields in the payload of the information frame: a common information field or a node information field.

In one embodiment, the method further includes:

generating, by the AP, the resource allocation indication information based on type information of the at least one STA.

In one embodiment, the receiving, by the AP, a reply message sent by one or more of the at least one STA includes:

receiving, by the AP, the reply message that is sent by different types of STAs in the at least one STA based on the resource allocation indication information by using a time division multiplexing resource.

In one embodiment, the resource information includes subunit information in a high efficient long training field HE-LTF in a high efficient HE preamble of the information frame, or subunit information in an Internet of Things long training field IoT-LTF in an Internet of Things IoT preamble of the information frame; where

the subunit information of the HE-LTF is corresponding to any one of the following: a sub-channel, the sub-channel and a time domain code, the sub-channel and a frequency domain code, or the sub-channel and a code; and

the subunit information of the IoT-LTF is corresponding to any one of the following: the sub-channel, the sub-channel and the time domain code, the sub-channel and the frequency domain code, or the sub-channel and the code.

By using the relay indication method provided in this implementation, the different types of STAs may send the reply messages to the APs in a time division multiplexing manner based on different resource information indicated by the resource allocation indication information, thereby improving data transmission efficiency.

According to a second aspect, an embodiment of this application provides an access point AP, including:

a sending module, configured to send relay indication information to at least one STA; and

a receiving module, configured to receive a reply message sent by one or more of the at least one STA.

In one embodiment, the relay indication information includes one or more of the following:

an indication about whether a relay STA is used for data transmission;

a quantity of relay STAs used for data transmission;

an identifier of the relay STA used for data transmission; or

an indication about whether a message sent by the relay STA carries a preamble.

In one embodiment, the sending module is specifically configured to send an information frame to the at least one STA, where the information frame includes the relay indication information.

In one embodiment, the relay indication information is located in a preamble, a service domain, a MAC header, or payload of the information frame.

In one embodiment, the relay indication information is located in an unused or a reusable field of the preamble, the service domain, the MAC header, or the payload of the information frame; or

the relay indication information is located in a newly added indication field of the preamble, the service domain, the MAC header, or the payload of the information frame.

In one embodiment, the relay indication information is located in one of the following fields of the preamble: a field indicating a MCS, a field indicating a quantity of streams, or a field indicating bandwidth.

In one embodiment, the sending module is specifically configured to send the relay indication information to the at least one STA in a first time period, where the relay indication information is forwarded by a relay STA in the at least one STA in a second time period to an Internet of Things STA within a management range of the relay STA.

In one embodiment, the receiving module is specifically configured to:

when the Internet of Things STA belongs to the at least one STA, receive, in the second time period, the reply message sent by a STA in the at least one STA other than the relay STA and the Internet of Things STA; or

when the Internet of Things STA does not belong to the at least one STA, receive, in the second time period, the reply message sent by a STA in the at least one STA other than the relay STA.

In one embodiment, the receiving module is further configured to receive acknowledgement information sent by the Internet of Things STA by using the relay STA, where the acknowledgement information is used to indicate, to the AP, that the Internet of Things STA can receive a frame sent by the AP.

In one embodiment, the information frame further includes relay condition information, where the relay condition information is used to indicate a preset condition for becoming the relay STA.

In one embodiment, the preset condition includes one or more of the following:

a link condition;

a STA service condition;

a power supply condition of the STA;

a quantity of other STAs within a preset range; or

a condition under which a target STA can be connected.

In one embodiment, the information frame further includes resource allocation indication information, and the resource allocation indication information is used to indicate, to the at least one STA, a resource used for sending the reply message.

In one embodiment, the resource allocation indication information is located in any one of the following fields in the payload of the information frame: a common information field or a node information field.

In one embodiment, the AP further includes:

a generation module, configured to generate the resource allocation indication information based on type information of the at least one STA.

In one embodiment, the receiving module is specifically configured to:

receive the reply message that is sent by different types of STAs in the at least one STA based on the resource allocation indication information by using a time division multiplexing resource.

In one embodiment, the resource information includes subunit information in a high efficient long training field HE-LTF in a high efficient HE preamble of the information frame, or subunit information in an Internet of Things long training field IoT-LTF in an Internet of Things IoT preamble of the information frame; where

the subunit information of the HE-LTF is corresponding to any one of the following: a sub-channel, the sub-channel and a time domain code, the sub-channel and a frequency domain code, or the sub-channel and a code; and

the subunit information of the IoT-LTF is corresponding to any one of the following: the sub-channel, the sub-channel and the time domain code, the sub-channel and the frequency domain code, or the sub-channel and the code.

For beneficial effects of the AP provided in the second aspect and each possible implementation of the second aspect, refer to the beneficial effects of each possible implementation of the first aspect. Details are not described herein again.

According to a third aspect, an embodiment of this application provides an access point AP, including a transmitter and a receiver; where

the transmitter is configured to send relay indication information to at least one STA; and

the receiver is configured to receive a reply message sent by one or more of the at least one STA.

In one embodiment, the relay indication information includes one or more of the following:

an indication about whether a relay STA is used for data transmission;

a quantity of relay STAs used for data transmission;

an identifier of the relay STA used for data transmission; or

an indication about whether a message sent by the relay STA carries a preamble.

In one embodiment, the transmitter is specifically configured to send an information frame to the at least one STA, where the information frame includes the relay indication information.

In one embodiment, the relay indication information is located in a preamble, a service domain, a MAC header, or payload of the information frame.

In one embodiment, the relay indication information is located in an unused or a reusable field of the preamble, the service domain, the MAC header, or the payload of the information frame; or

the relay indication information is located in a newly added indication field of the preamble, the service domain, the MAC header, or the payload of the information frame.

In one embodiment, the relay indication information is located in one of the following fields of the preamble: a field indicating a MCS, a field indicating a quantity of streams, or a field indicating bandwidth.

In one embodiment, the transmitter is specifically configured to send the relay indication information to the at least one STA in a first time period, where the relay indication information is forwarded by a relay STA in the at least one STA in a second time period to an Internet of Things STA within a management range of the relay STA.

In one embodiment, the receiver is specifically configured to:

when the Internet of Things STA belongs to the at least one STA, receive, in the second time period, the reply message sent by a STA in the at least one STA other than the relay STA and the Internet of Things STA; or

when the Internet of Things STA does not belong to the at least one STA, receive, in the second time period, the reply message sent by a STA in the at least one STA other than the relay STA.

In one embodiment, the receiver is further configured to receive acknowledgement information sent by the Internet of Things STA by using the relay STA, where the acknowledgement information is used to indicate, to the AP, that the Internet of Things STA can receive a frame sent by the AP.

In one embodiment, the information frame further includes relay condition information, where the relay condition information is used to indicate a preset condition for becoming the relay STA.

In one embodiment, the preset condition includes one or more of the following:

a link condition;

a STA service condition;

a power supply condition of the STA;

a quantity of other STAs within a preset range; or

a condition under which a target STA can be connected.

In one embodiment, the information frame further includes resource allocation indication information, and the resource allocation indication information is used to indicate, to the at least one STA, a resource used for sending the reply message.

In one embodiment, the resource allocation indication information is located in any one of the following fields in the payload of the information frame: a common information field or a node information field.

one embodiment, the AP further includes:

a processor, configured to generate the resource allocation indication information based on type information of the at least one STA.

In one embodiment, the receiver is specifically configured to:

receive the reply message that is sent by different types of STAs in the at least one STA based on the resource allocation indication information by using a time division multiplexing resource.

In one embodiment, the resource information includes subunit information in a high efficient long training field (HE-LTF) in a high efficient (HE) preamble of the information frame, or subunit information in an Internet of Things long training field (IoT-LTF) in an Internet of Things IoT preamble of the information frame; where

the subunit information of the HE-LTF is corresponding to any one of the following: a sub-channel, the sub-channel and a time domain code, the sub-channel and a frequency domain code, or the sub-channel and a code; and

the subunit information of the IoT-LTF is corresponding to any one of the following: the sub-channel, the sub-channel and the time domain code, the sub-channel and the frequency domain code, or the sub-channel and the code.

For beneficial effects of the AP provided in the third aspect and each possible implementation of the third aspect, refer to the beneficial effects of each possible implementation of the first aspect. Details are not described herein again.

### BRIEF DESCRIPTION OF DRAWINGS

FIG. 1A is a schematic flowchart of Embodiment 1 of a relay indication method according to this application;

FIG. 1B is a first schematic structural diagram of an information frame;

FIG. 1C is a first schematic flowchart of a relay indication method according to this application;

FIG. 1D is a second schematic flowchart of a relay indication method according to this application;

FIG. 1E is a third schematic flowchart of a relay indication method according to this application;

FIG. 1F is a fourth schematic flowchart of a relay indication method according to this application;

FIG. 2A is a first schematic flowchart of Embodiment 2 of a relay indication method according to this application;

FIG. 2B is a second schematic flowchart of Embodiment 2 of a relay indication method according to this application;

FIG. 3A is a first schematic flowchart of Embodiment 3 of a relay indication method according to this application;

FIG. 3B-1 and FIG. 3B-2 are a second schematic flowchart of Embodiment 3 of a relay indication method according to this application;

FIG. 4A is a first schematic flowchart of Embodiment 4 of a relay indication method according to this application;

FIG. 4B-1 and FIG. 4B-2 are a second schematic flowchart of Embodiment 4 of a relay indication method according to this application;

FIG. 5A is a schematic diagram of a frame structure of IEEE 802.11ax;

FIG. 5B is a first schematic diagram of resource information;

FIG. 5C is a second schematic diagram of resource information;

FIG. 5D is a third schematic diagram of resource information;

FIG. 5E is a fourth schematic diagram of resource information;

FIG. 5F is a fifth schematic diagram of resource information;

FIG. 5G is a second schematic structural diagram of an information frame;

FIG. 6 is a sixth schematic diagram of resource information;

FIG. 7 is a schematic structural diagram of Embodiment 1 of an AP according to this application;

FIG. 8 is a schematic structural diagram of Embodiment 2 of an AP according to this application;

FIG. 9 is a schematic structural diagram of Embodiment 3 of an AP according to this application; and

FIG. 10 is a schematic structural diagram of Embodiment 4 of an AP according to this application.

### DESCRIPTION OF EMBODIMENTS

An access point (AP) used in this application is also referred to as a wireless access point, a bridge, a hotspot, or the like, and may access a server, a communications network, or the like.

A station (STA) used in this application may also be referred to as a user, and may be a wireless sensor, a wireless communications terminal, or a mobile terminal, such as a mobile phone (or referred to as a “cellular” phone) supporting a Wireless Fidelity (Wi-Fi) communications function or a computer having a wireless communications function. For example, the station may be a portable, pocket-sized, handheld, computer built-in, wearable, or in-vehicle wireless communications apparatus that supports a Wi-Fi communications function and exchanges communications data such as voice or data with a radio access network. The STA used in this application may be an IoT STA or an HE STA. The HE STA has a narrowband sending capability and a broadband sending capability (for example, 20 MHz). The IoT STA has a narrowband sending capability, and narrowband refers to an operating bandwidth (for example, 20 MHz) narrower than that of the HE STA, for example, 2 MHz.

A preamble used in this application includes at least one of the following: a legacy preamble, a high efficient (HE) preamble, and an IoT preamble. Optionally, if the preamble includes the legacy preamble, the HE preamble, and the IoT preamble, the legacy preamble precedes the HE preamble, and the IoT preamble follows the HE preamble. Optionally, there may be no interval between the HE preamble and the IoT preamble, or there may be an XIFS between the HE preamble and the IoT preamble.

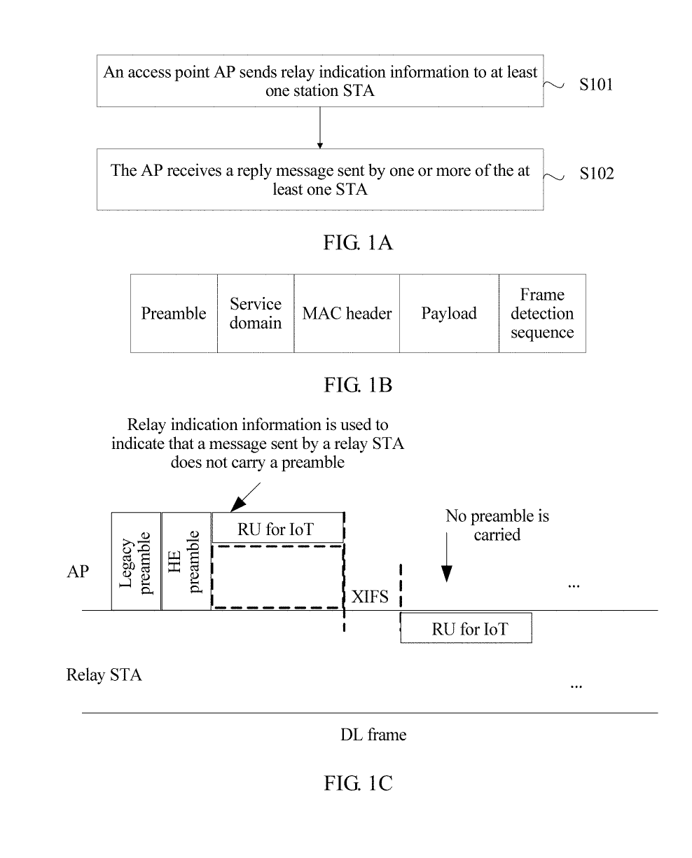

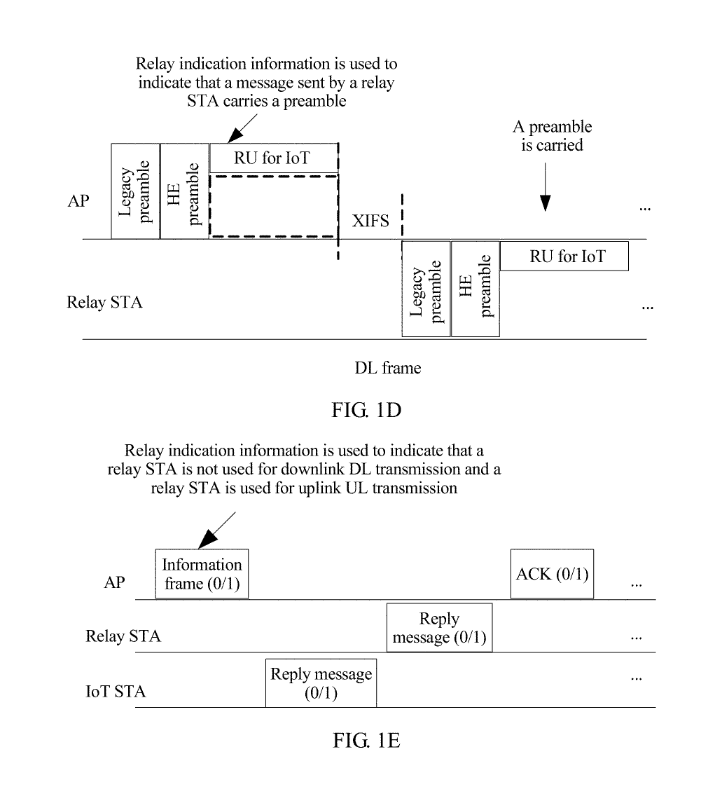

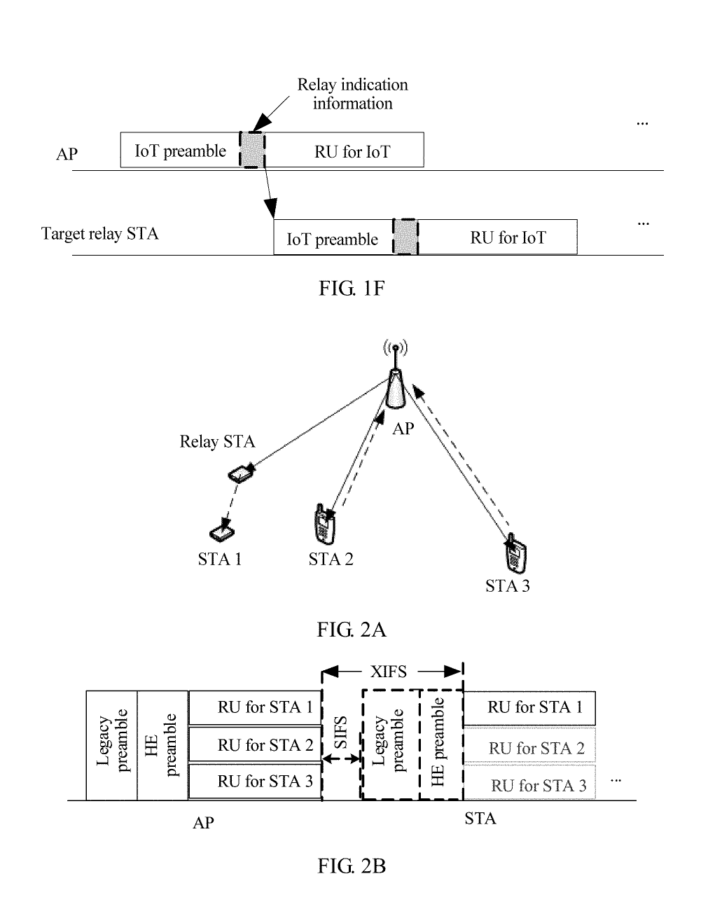

FIG. 1A is a schematic flowchart of Embodiment 1 of a relay indication method according to this application. As shown in FIG. 1A, the method in this embodiment may include the following operations.

In operation 101, an access point AP sends relay indication information to at least one STA.

In this embodiment, the AP sends the relay indication information to the at least one STA. Optionally, the relay indication information includes one or more of the following: an indication about whether a relay STA is used for data transmission (so that the at least one STA determines, based on the indication, whether to use the relay STA for uplink transmission and downlink transmission), a quantity of relay STAs used for data transmission (so that the at least one STA determines a quantity of relay STAs used for uplink transmission and downlink transmission), an identifier of the relay STA used for data transmission (which is used to enable a target relay STA to prepare for relay, and further enable a non-target relay STA to make an adjustment in advance for energy saving), and an indication about whether a message sent by the relay STA carries a preamble (so that the relay STA determines, based on the indication, whether the message sent by the relay STA carries the preamble).

In one embodiment, the AP sends an information frame to the at least one STA, where the information frame includes the relay indication information. In one embodiment, the relay indication information is located in a preamble, a service domain, a MAC header, or payload of the information frame, as shown in FIG. 1B (FIG. 1B is a first schematic structural diagram of the information frame). In one embodiment, the relay indication information is located in an unused or a reusable field of the preamble, the service domain, the MAC header, or the payload of the information frame; or the relay indication information is located in a newly added indication field of the preamble, the service domain, the MAC header, or the payload of the information frame; or the relay indication information is located in one of the following fields of the preamble: a field indicating a MCS, a field indicating a quantity of streams, or a field indicating bandwidth. In one embodiment, the information frame may be a frame of any type, such as a data frame, a trigger frame, a management frame, or a control frame. This is not limited in this embodiment of this application.

(1) When the relay indication information is located in the unused or the reusable field of the preamble, the service domain, the MAC header, or the payload of the information frame; or when the relay indication information is located in the newly added indication field of the preamble, the service domain, the MAC header, or the payload of the information frame, the relay indication information may occupy one bit (bit) or a plurality of bits. This is not limited in this embodiment of this application. The following describes corresponding manners of carrying the relay indication information when the relay indication information includes different information.

(1) The relay indication information includes the indication about whether the message sent by the relay STA carries the preamble. In one embodiment, the preamble includes at least one of the following: a legacy preamble, an HE preamble, and an IoT preamble. In one embodiment, (A) when the relay indication information occupies one bit, if a value of the bit is 1, the message sent by the relay STA carries the legacy preamble, the HE preamble, and the IoT preamble; or if a value of the bit is 0, the message sent by the relay STA does not carry the legacy preamble, the HE preamble, or the IoT preamble; (B) when the relay indication information occupies two bits, if a value of the two bits is 11, the message sent by the relay STA carries the legacy preamble, the HE preamble, and the IoT preamble; or if a value of the two bits is 00, the message sent by the relay STA does not carry the legacy preamble, the HE preamble, or the IoT preamble; or if a value of the two bits is 10, the message sent by the relay STA carries the legacy preamble; or if a value of the two bits is 01, the message sent by the relay STA carries the HE preamble and the IoT preamble, or the value represents null (that is, no information is indicated); (C) when the relay indication information occupies three bits, if a value of the three bits is 111, the message sent by the relay STA carries the legacy preamble, the HE preamble, and the IoT preamble; if a value of the three bits is 000, the message sent by the relay STA does not carry the legacy preamble, the HE preamble, or the IoT preamble; or if a value of the three bits is 100, the message sent by the relay STA carries the legacy preamble; or if a value of the three bits is 010, the message sent by the relay STA carries the HE preamble, or the value represents null (that is, no information is indicated); or if a value of the three bits is 001, the message sent by the relay STA carries the IoT preamble, or the value represents null (that is, no information is indicated). Certainly, the foregoing examples are only used for description. The relay indication information may alternatively occupy another quantity of bits, and a value of the occupied bits may be another value, and/or different values represent different meanings. This is not limited in this embodiment of this application. FIG. 1C is a first schematic flowchart of a relay indication method according to this application. FIG. 1D is a second schematic flowchart of a relay indication method according to this application. As shown in FIG. 1C, the relay indication information is used to indicate that the message sent by the relay STA does not carry the preamble (for example, the legacy preamble and the HE preamble). As shown in FIG. 1D, the relay indication information is used to indicate that the message sent by the relay STA carries the preamble (for example, the legacy preamble and the HE preamble).

(2) The relay indication information includes the indication about whether the relay STA is used for data transmission. In one embodiment, (A) when the relay indication information occupies two bits, if a value of the two bits is 00, the relay STA is not used for data transmission (that is, uplink transmission and downlink transmission); or if a value of the two bits is 01, the relay STA is not used for downlink (DL) transmission, and the relay STA is used for uplink (UL) transmission; or if a value of the two bits is 10, the relay STA is used for DL transmission, and the relay STA is not used for UL transmission; or if a value of the two bits is 11, the relay STA is used for both DL transmission and UL transmission. Certainly, the foregoing examples are only used for description. The relay indication information may alternatively occupy another quantity of bits, and a value of the occupied bits may be another value, and/or different values represent different meanings. This is not limited in this embodiment of this application. FIG. 1E is a third schematic flowchart of a relay indication method according to this application. As shown in FIG. 1E, if the relay indication information occupies two bits and a value of the two bits is 01, the relay STA is not used for downlink DL transmission, and the relay STA is used for uplink UL transmission, and then the IoT STA transmits data by using the relay STA during the UL transmission, for example, the IoT STA sends a reply message to the AP based on the relay indication information by using the relay STA.

(3) The relay indication information includes: the indication about whether the relay STA is used for data transmission and the quantity of relay STAs used for data transmission. In one embodiment, when the relay indication information occupies (m+n) bits, m bits are used to indicate whether the relay STA is used for DL transmission and indicate the quantity of relay STAs used for DL transmission (for example, m=2, and if a value of the two bits is 00, no relay STA is used for DL transmission; or if a value of the two bits is 01, one relay STA is used for DL transmission; or if a value of the two bits is 10, two relay STAs are used for DL transmission; or if a value of the two bits is 11, three relay STAs are used for DL transmission), and n bits are used to indicate whether the relay STA is used for UL transmission and indicate the quantity of relay STAs used for UL transmission (a manner in which the n bits are used to indicate whether the relay STA is used for DL transmission and indicate the quantity of relay STAs used for DL transmission is similar to the manner in which the m bits are used to indicate whether the relay STA is used for DL transmission and indicate the quantity of relay STAs used for DL transmission, and details are not described herein again). Certainly, the foregoing examples are only used for description. The relay indication information may alternatively occupy another quantity of bits, and a value of the occupied bits may be another value, and/or different values represent different meanings. This is not limited in this embodiment of this application.

(4) The relay indication information includes the identifier of the relay STA used for data transmission. In one embodiment, the identifier of the relay STA may be one or more of the following: a MAC address of the relay STA, an association ID (AID) of the relay STA, a partial association identification (PAID) of the relay STA, or an independent ID of the relay STA (an ID independently allocated to the relay STA in advance). Certainly, the identifier of the relay STA may alternatively be other information that may be used to indicate the identifier of the relay STA, and this is not limited in this embodiment of this application. In one embodiment, if the preamble of the information frame includes the IoT preamble, the relay indication information may be located in the IoT preamble, and the target relay STA may learn, as soon as possible, whether to provide assistance in transmission, so as to prepare for relay as soon as possible. In one embodiment, if the preamble of the information frame includes the HE preamble, the relay indication information may be located in the HE preamble, and the target relay STA is capable of parsing the HE preamble (that is, has a 20 MHz receiving capability). FIG IF is a fourth schematic flowchart of a relay indication method according to this application. As shown in FIG. 1F, the relay indication information is located in the IoT preamble. After receiving the relay indication information carried in the IoT preamble, the target relay STA may learn whether to provide assistance in transmission, so as to prepare for relay as soon as possible.

After receiving the relay indication information that carries the identifier of the relay STA used for data transmission, the following cases may occur, depending on a capability of the relay STA.

I. When the relay STA has only one radio frequency link (Single RF chain), that is, cannot support full duplex, after receiving an information frame that carries the relay indication information, and determining, by using the identifier that is of the relay STA used for data transmission and that is included in the relay indication information, that the information frame matches the relay STA, the relay STA determines that the relay STA needs to be used as the relay to provide assistance in forwarding the information frame, and a subsequent operation may be:

a. normally receiving the information frame and decoding the information frame, and immediately forwarding the information frame after receiving is complete;

b. normally receiving the information frame and decoding the information frame, and forwarding the information frame at XIFS after receiving is complete;

c. normally receiving the information frame and buffering the information frame, and immediately forwarding the information frame after receiving is complete; or

d. normally receiving the information frame and buffering the information frame, and forwarding the information frame at XIFS after receiving is complete.

II. When the relay STA has two radio frequency links (Dual-RF chain), that is, supports full duplex, after receiving an information frame that carries the relay indication information, and determining, by using the identifier that is of the relay STA used for data transmission and that is included in the relay indication information, that the information frame matches the relay STA, the relay STA determines that the relay STA needs to be used as the relay to provide assistance in forwarding the information frame, and a subsequent operation may be:

a. immediately starting to forward the information frame (that is, receiving while sending), as shown in FIG. 1F; In one embodiment, a frequency band that is same as the original receiving frequency band may be used for forwarding, or a frequency band that is different from the original receiving frequency band may be used;

b. normally receiving the information frame and decoding the information frame, and immediately forwarding the information frame after receiving is complete;

c. normally receiving the information frame and decoding the information frame, and forwarding the information frame at XIFS after receiving is complete;

d. normally receiving the information frame and buffering the information frame, and immediately forwarding the information frame after receiving is complete;

or

e. normally receiving the information frame and buffering the information frame, and forwarding the information frame at XIFS after receiving is complete.

(II) When the relay indication information is located in the field that indicates the MCS and that is in the preamble of the information frame, the relay indication information is represented by using a special value of the field indicating the MCS or another value that is not used. In one embodiment, the relay indication information includes one or more of the following: the indication about whether the relay STA is used for data transmission, the quantity of relay STAs used for data transmission, the identifier of the relay STA used for data transmission, and the indication about whether the message sent by the relay STA carries the preamble. For example, when the relay indication information includes the indication about whether the message sent by the relay STA carries the preamble, and a preset value of the field indicating the MCS is MCS 11 (in one embodiment, the MCS 11 is an unused value), the message sent by the relay STA carries the preamble. A case in which the relay indication information includes other indication information is similar to this, and details are not described again in this embodiment of this application. In one embodiment, locations of the fields that indicate the MCS and that are in the preamble include any of the following locations: L-SIG, HE-SIG-A, HE-SIG-B, and HE-SIG.

When the relay indication information is located in the field that indicates the quantity of streams and that is in the preamble of the information frame, the relay indication information is represented by using a special value of the field indicating the quantity of streams or another value that is not used. In one embodiment, the relay indication information includes one or more of the following: the indication about whether the relay STA is used for data transmission, the quantity of relay STAs used for data transmission, the identifier of the relay STA used for data transmission, or the indication about whether the message sent by the relay STA carries the preamble. A manner in which the relay indication information is represented by using the special value of the field indicating the quantity of streams or the another value that is not used is similar to the foregoing manner in which the relay indication information is represented by using the special value of the field indicating the MCS or the another value that is not used, and details are not described herein again.

When the relay indication information is located in the field that indicates the bandwidth and that is in the preamble of the information frame, the relay indication information is represented by using a special value of the field indicating the bandwidth or another value that is not used. In one embodiment, the relay indication information includes one or more of the following: the indication about whether the relay STA is used for data transmission, the quantity of relay STAs used for data transmission, the identifier of the relay STA used for data transmission, or the indication about whether the message sent by the relay STA carries the preamble. A manner in which the relay indication information is represented by using the special value of the field indicating the bandwidth or the another value that is not used is similar to the foregoing manner in which the relay indication information is represented by using the special value of the field indicating the MCS or the another value that is not used, and details are not described herein again.

In operation 102, the AP receives a reply message sent by one or more of the at least one STA.

In this embodiment, after sending the relay indication information to the at least one STA, the AP further receives the reply message sent by one or more of the at least one STA based on the relay indication information. It can be learned that relay communication in an IoT communications system is implemented.

In this embodiment, the AP sends the relay indication information to the at least one STA, and further, receives the reply message sent by one or more of the at least one STA based on the relay indication information. It can be learned that relay communication in an IoT communications system is implemented.

In one embodiment, operation 101 includes that: The AP sends the relay indication information to the at least one STA in a first time period, where the relay indication information is forwarded by a relay STA in the at least one STA in a second time period to an Internet of Things STA within a management range of the relay STA.

Accordingly, operation 102 includes that:

when the Internet of Things STA belongs to the at least one STA, the AP receives, in the second time period, the reply message sent by a STA in the at least one STA other than the relay STA and the Internet of Things STA; or

when the Internet of Things STA does not belong to the at least one STA, the AP receives, in the second time period, the reply message sent by a STA in the at least one STA other than the relay STA.

In this embodiment, the AP sends the relay indication information to the at least one STA in the first time period. In one embodiment, the relay indication information includes: the indication about whether the relay STA is used for data transmission (for example, that the relay STA is used for both DL transmission and UL transmission is indicated, and certainly, the relay indication information may further include other indication information, which is not limited in this embodiment of this application). Further, the relay STA in the at least one STA forwards, in the second time period, the relay indication information to the Internet of Things STA within the management range of the relay STA. In addition, (A) when the Internet of Things STA belongs to the at least one STA, the STA in the at least one STA other than the relay STA and the Internet of Things STA sends the reply message to the AP in the second time period; correspondingly, the AP receives, in the second time period, the reply message sent by the STA in the at least one STA other than the relay STA and the Internet of Things STA; optionally, the AP may receive acknowledgement information sent by the Internet of Things STA by using the relay STA; optionally, the acknowledgement information is used to indicate, to the AP, that the Internet of Things STA can receive a frame sent by the AP (that is, the Internet of Things STA may directly receive the frame sent by the AP without the relay STA); and optionally, the frame may be the information frame that carries the relay indication information; (B) When the Internet of Things STA does not belong to the at least one STA, the STA in the at least one STA other than the relay STA sends the reply message to the AP in the second time period; and correspondingly, the AP receives, in the second time period, the reply message sent by the STA in the at least one STA other than the relay STA. It can be learned that, in this embodiment, both UL transmission and DL transmission are included in a same time period, thereby implementing hybrid transmission.

FIG. 2A is a first schematic flowchart of Embodiment 2 of a relay indication method according to this application. FIG. 2B is a second schematic flowchart of Embodiment 2 of the relay indication method according to this application. With reference to FIG. 2A and FIG. 2B, (1) a source node (for example, an AP) separately sends an information frame (optionally, the information frame carries relay indication information) to a relay STA, a STA 2, and a STA 3 in a first time period by using corresponding resource units (RU); optionally, the relay STA may be an IoT STA or an HE STA, and the STA 2 and the STA 3 may be the HE STAs; and certainly, the STA 2 and the STA 3 may alternative be STAs of another type, and this is not limited in this application; (2) the relay STA forwards the information frame to the STA 1 in a second time period by using the corresponding RU (certainly, the relay STA may also send, to the STA 1, information that needs to be sent to the STA 1 by the relay STA), and optionally, the STA 1 is the IoT STA; in addition, the STA 2 and the STA 3 send reply messages to the AP on the corresponding RUs; optionally, XIFS=a short inter-frame space (SIFS)+a time of a legacy preamble+a time of an HE preamble; and certainly, the XIFS in different application scenarios may further be determined in another calculation manner, and this is not limited in this embodiment of this application. It can be learned that, both UL transmission and DL transmission are included in a same time period, thereby implementing hybrid transmission.

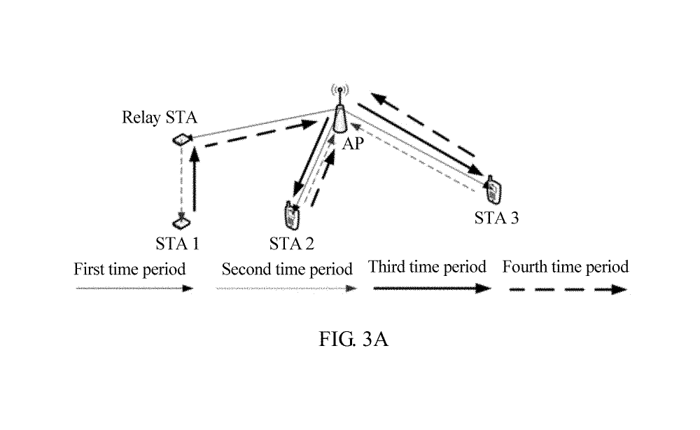

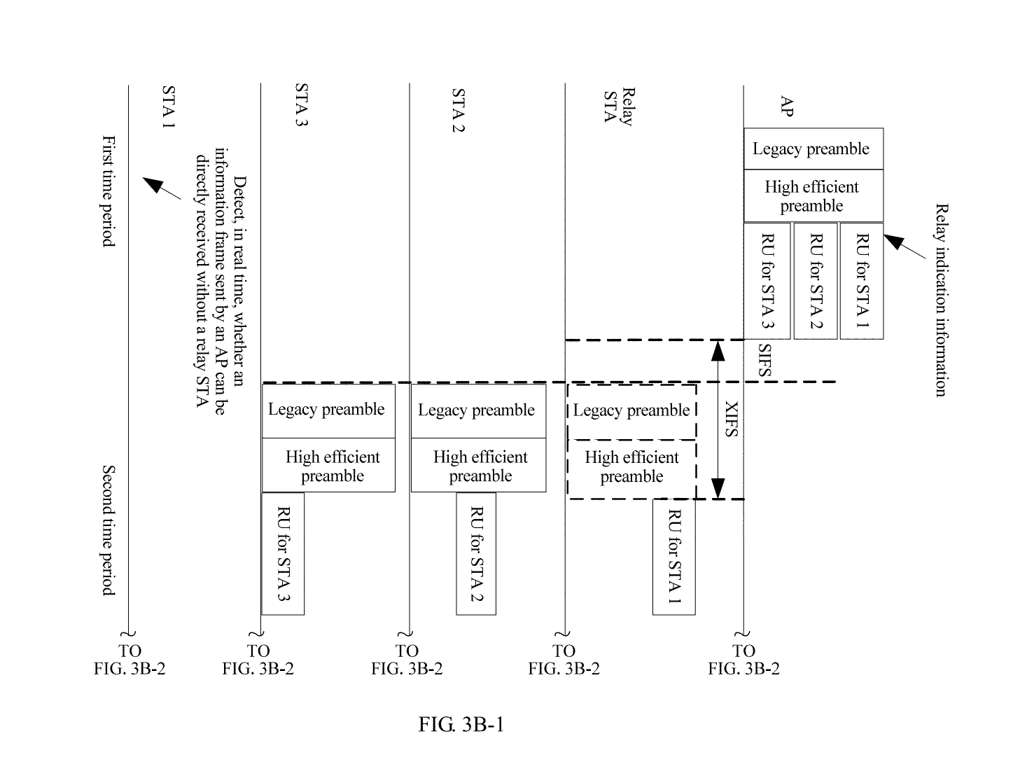

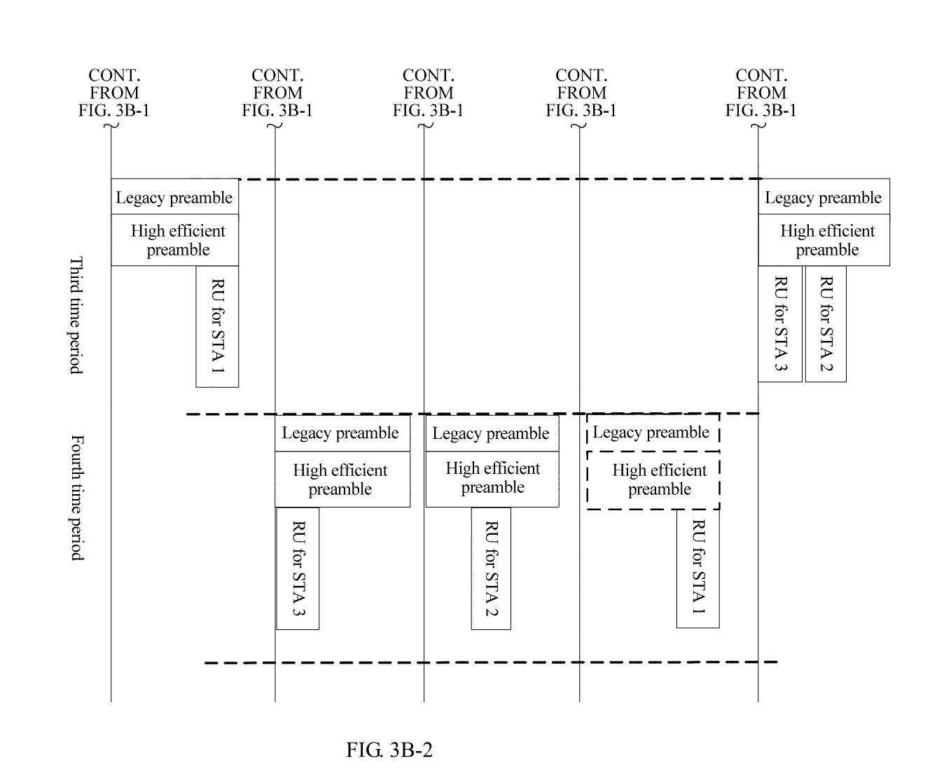

FIG. 3A is a first schematic flowchart of Embodiment 3 of a relay indication method according to this application. FIG. 3B-1 and FIG. 3B-2 are a second schematic flowchart of Embodiment 3 of the relay indication method according to this application. With reference to FIG. 3A, FIG. 3B-1, and FIG. 3B-2, (1) a source node (for example, an AP) separately sends an information frame to a relay STA, a STA 2, and a STA 3 in a first time period by using corresponding RUs; optionally, the information frame carries relay indication information; and optionally, the relay indication information includes: an indication about whether a relay STA is used for data transmission (for example, that the relay STA is used for both DL transmission and UL transmission is indicated), and an indication about whether a message sent by the relay STA carries a preamble (for example, that the message sent by the relay STA does not carry the preamble is indicated); optionally, the relay STA may be an IoT STA or an HE STA, and the STA 2 and the STA 3 may be the HE STAs, and certainly, the STA 2 and the STA 3 may be STAs of another type, and this is not limited in this application; (2) the relay STA forwards the information frame to the STA 1 in a second time period by using the corresponding RU (certainly, the relay STA may also send, to the STA 1, information that needs to be sent to the STA 1 by the relay STA), optionally, the STA 1 is the IoT STA; in the first time period, the STA 1 detects, in real time, whether the STA 1 can directly receive the information frame sent by the AP without the relay STA, if the STA 1 may directly receive the information frame sent by the AP, the STA 1 sends a first uplink frame that carries acknowledgement information to the AP in a third time period, optionally, the acknowledgement information is used to indicate, to the AP, that the STA 1 can receive a frame sent by the AP (that is, the STA 1 may directly receive the information frame sent by the AP without the relay STA); in addition, the STA 2 and the STA 3 separately send a reply message to the AP in the second time period by using the corresponding RUs; (3) the AP sends a first downlink frame to the STA 2 and the STA 3 in a third time period; in addition, the STA 1 sends, to the AP by using the corresponding RU, the first uplink frame that carries the acknowledgement information; optionally, the acknowledgement information may occupy one bit or more bits, and may be located at any location of the first uplink frame, for example, a preamble, a service domain, a MAC header, payload, or the like; (4) the STA 2 and the STA 3 separately send a second uplink frame to the AP by using the corresponding RUs in a fourth time period; in addition, the relay STA forwards the first uplink frame sent by the STA 1 to the AP in the fourth time period (that is, the AP can learn that the STA 1 may directly receive the information frame sent by the AP without the relay STA), so that the AP can re-determine whether the relay STA is used for data transmission.

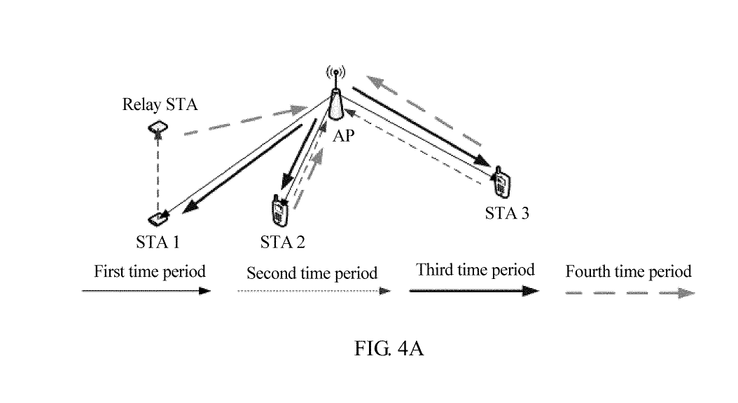

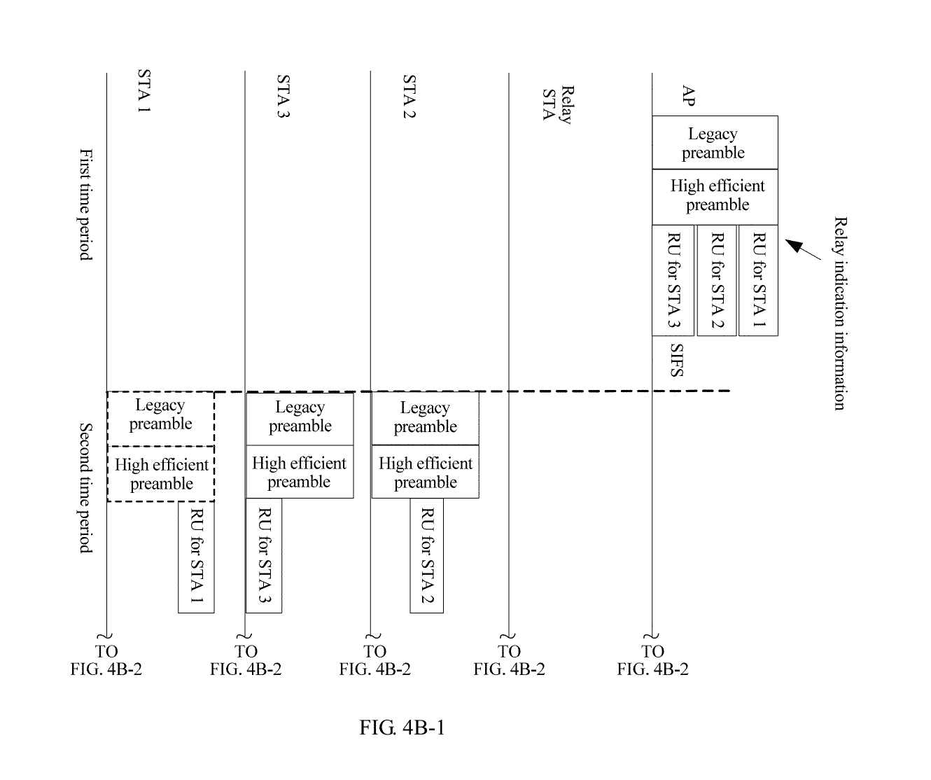

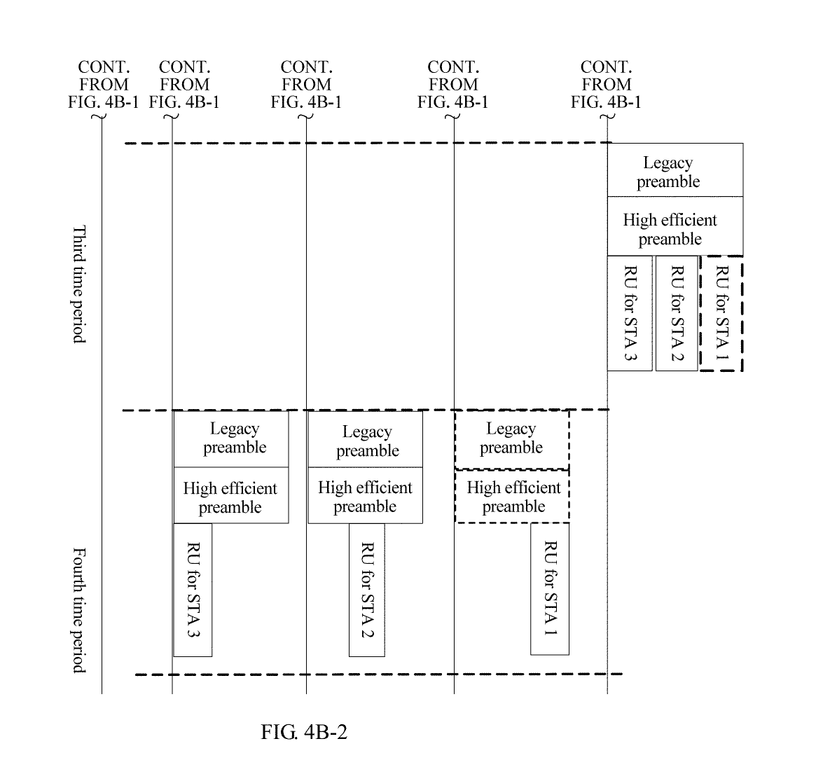

FIG. 4A is a first schematic flowchart of Embodiment 4 of a relay indication method according to this application. FIG. 4B-1 and FIG. 4B-2 are a second schematic flowchart of Embodiment 4 of the relay indication method according to this application. With reference to FIG. 4A, FIG. 4B-1, and FIG. 4B-2, it is assumed that a source node (for example, an AP) has learned that a STA 1 may directly receive a frame sent by the AP without a relay STA, (1) the AP separately sends an information frame to the relay STA, the STA 1, a STA 2, and a STA 3 in a first time period by using corresponding RUs; optionally, the information frame carries relay indication information; and optionally, the relay indication information includes: an indication about whether the relay STA is used for data transmission (for example, that the relay STA is not used for DL transmission and the relay STA is used for UL transmission is indicated), and an indication about whether a message sent by the relay STA carries a preamble (for example, that the message sent by the relay STA does not carry the preamble is indicated); optionally, the relay STA may be an IoT STA or an HE STA, the STA 1 is the IoT STA, and the STA 2 and the STA 3 may be the HE STAs; and certainly, the STA 2 and the STA 3 may be STAs of another type, and this is not limited in this application; (2) the STA 2 and the STA 3 separately send a reply message to the AP in a second time period by using corresponding RUs; in addition, because the relay indication information indicates that the relay STA is used for UL transmission, the STA 1 sends the reply message to the relay STA in the second time period by using the corresponding RU, so that the relay STA forwards the reply message to the AP; (3) the AP separately sends a first downlink frame to the STA 1, the STA 2, and the STA 3 in a third time period; (4) the STA 2 and the STA 3 separately send a first uplink frame to the AP on the corresponding RUs; in addition, the relay STA forwards the reply message sent by the STA 1 to the AP in a fourth time period.

In one embodiment, based on Embodiment 1 of the foregoing relay indication method, the information frame further includes relay condition information, where the relay condition information is used to indicate a preset condition for becoming the relay STA, for example, a STA that meets the preset condition may become the relay STA. Optionally, the preset condition includes one or more of the following: a link condition (optionally, the link condition includes a preset condition of a link from the AP to the relay STA and/or a preset condition of a link from the relay STA to a target STA), a STA service condition (optionally, the STA service condition is used to indicate a service busy degree of the STA), a power supply condition of the STA (optionally, the power supply condition of the STA is used to indicate whether the STA has power supply), a quantity of other STAs within a preset range, and a condition under which a target STA can be connected. Certainly, the preset condition may further include other condition information, and this is not limited in this embodiment of this application. Further, the STA that meets the preset condition may send the reply message to the AP on a corresponding resource, so as to indicate that the STA meets the preset condition and may become the relay STA. Optionally, in this embodiment, the information frame may be a trigger frame.

Further, the information frame further includes resource allocation indication information, and the resource allocation indication information is used to indicate, to at least one STA, a resource used for sending the reply message. Optionally, the resource information includes subunit information in a high efficient long training field HE-LTF in a high efficient HE preamble of the information frame, or subunit information in an Internet of Things long training field IoT-LTF in an Internet of Things IoT preamble of the information frame. The subunit information of the HE-LTF is corresponding to any one of the following: a sub-channel, the sub-channel and a time domain code, the sub-channel and a frequency domain code, or the sub-channel and a code. The subunit information of the IoT-LTF is corresponding to any one of the following: the sub-channel, the sub-channel and the time domain code, the sub-channel and the frequency domain code, or the sub-channel and the code.

(1) The subunit information of the HE-LTF and/or the subunit information of the IoT-LTF are/is corresponding to the sub-channels/the sub-channel.

The sub-channel may be corresponding to one subcarrier (that is, an RU) of OFDMA, or may be corresponding to a plurality of subcarriers.

(2) The subunit information of the HE-LTF and/or the subunit information of the IoT-LTF are/is corresponding to the sub-channels and the time domain codes/the sub-channel and the time domain code.

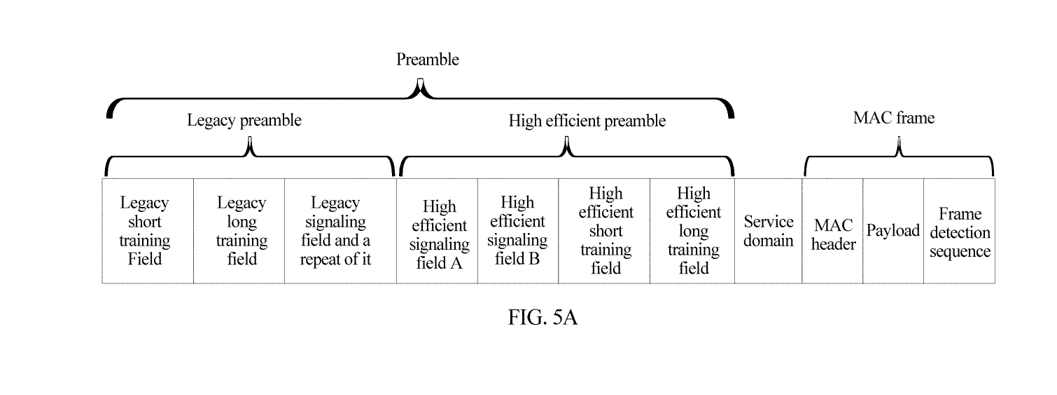

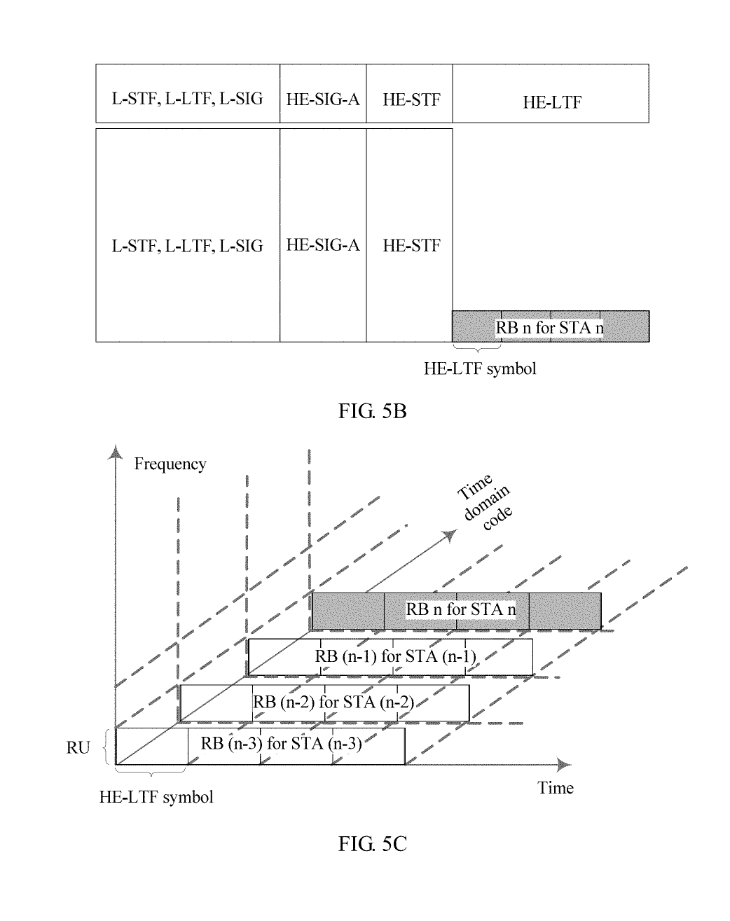

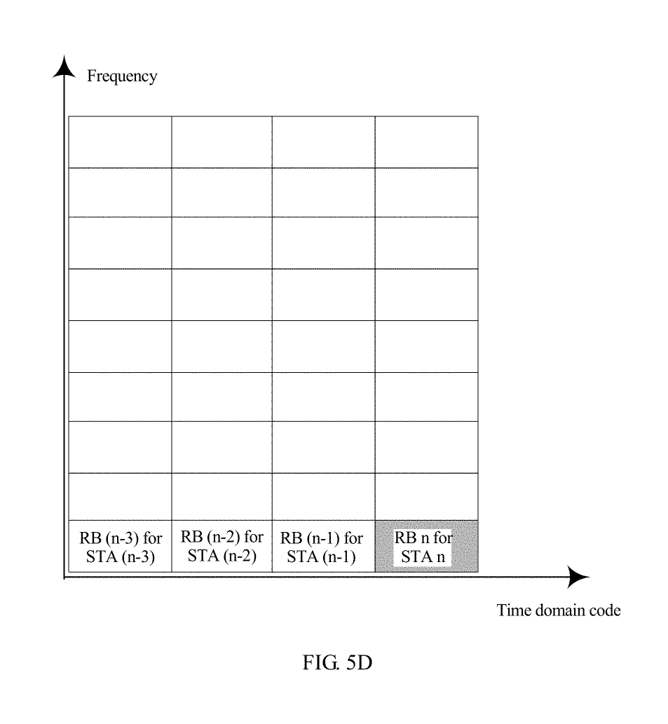

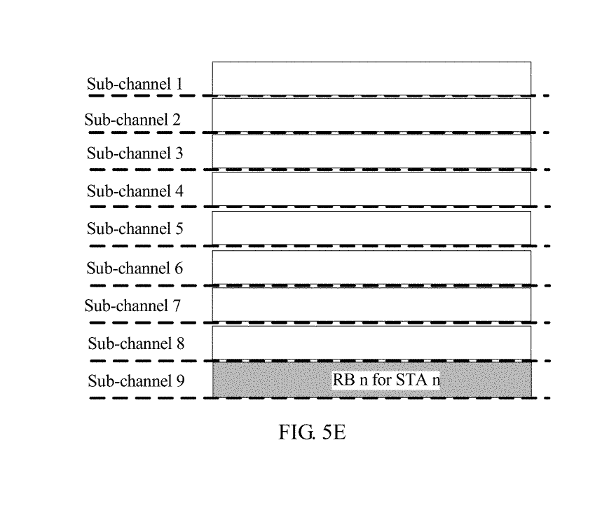

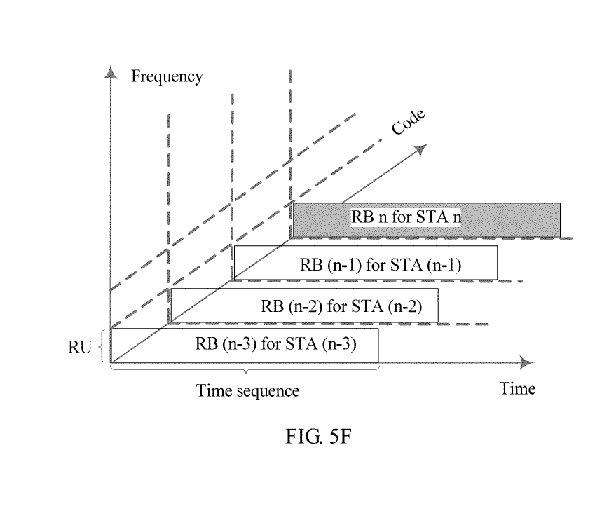

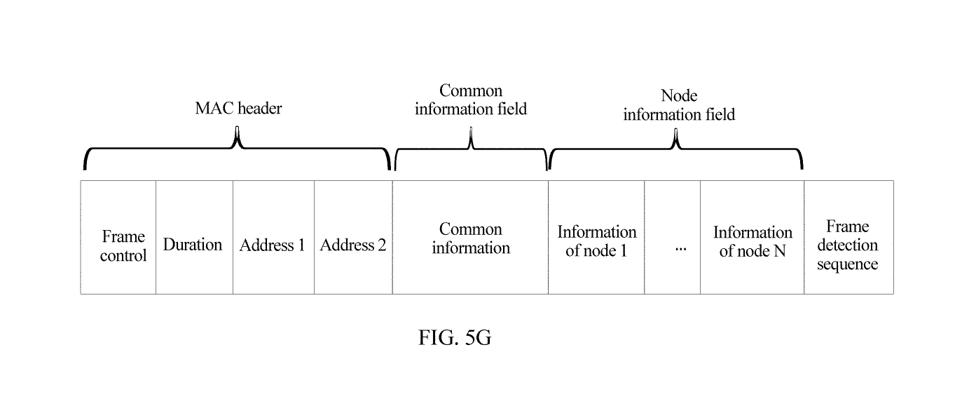

A Part before the HE-LTF in the information frame complies with an existing frame structure, for example, a frame structure of IEEE 802.11ax, as shown in FIG. 5A (FIG. 5A is a schematic diagram of the frame structure of IEEE 802.11ax), including a preamble, a service domain, and a MAC frame, where the preamble includes a legacy preamble and/or a high efficient preamble. The legacy preamble may include a legacy short training field (L-STF), a legacy long training field (L-LTF), and a legacy signal field (L-SIG). The high efficient preamble may include a high efficient signal field A (HE-SIG-A), a high efficient short training field (HE-STF), and a high efficient long training field (HE-LTF). In time domain, the HE-LTF is multiplied by different time domain codes to distinguish between different nodes (the time domain code may be any row of a matrix P, and a size of the matrix P may be determined by the AP based on a quantity of receiving nodes that need to communicate), the following uses that the size of the P matrix is 4×4 as an example for detailed description. As shown in FIG. 5B (FIG. 5B is a first schematic diagram of resource information) and FIG. 5C (FIG. 5C is a second schematic diagram of the resource information), the HE-LTF is extended to four HE-LTF symbols in time domain, and a row of the P matrix is corresponding to one node, where four time domain codes in the row are respectively multiplied by the four HE-LTF symbols to which the HE-LTF is extended in the time domain (that is, one time domain code is multiplied by one HE-LTF symbol). Because rows of the matrix P are orthogonal to each other, four different nodes may be allowed to transmit data on one sub-channel (or one RU). It can be learned that, one time domain code in one sub-channel is corresponding to one resource block, or different time domain codes in a same sub-channel may be used as the resource information to distinguish between nodes. For example, as shown in FIG. 5C, a node that meets the preset condition may send the reply message on a corresponding resource block indicated by the AP.

(3) The subunit information of the HE-LTF and/or the subunit information of the IoT-LTF are/is corresponding to the sub-channels and the frequency domain codes/the sub-channel and the frequency domain code.

The part preceding the HE-LTF in the information frame complies with the existing frame structure, for example, the frame structure of the IEEE 802.11ax. In frequency domain, the HE-LTF is directly multiplied by different frequency domain codes to distinguish between different nodes (the frequency domain code may be any row of the matrix P, and the size of the matrix P may be determined by the AP based on the quantity of receiving nodes that need to communicate). It can be learned that, one frequency domain code in one sub-channel (or one RU) is corresponding to one resource block, or different frequency domain codes in the same sub-channel may be used as the resource information to distinguish between nodes. For example, as shown in FIG. 5D (5D is a third schematic diagram of the resource information), the node that meets the preset condition may send the reply message on the corresponding resource block indicated by the AP.

(4) The subunit information of the HE-LTF and/or the subunit information of the IoT-LTF are/is corresponding to the sub-channels and the codes/the sub-channel and the code.

The code is directly corresponding to the node. Optionally, the code may be any row of the matrix P, and the size of the matrix P may be determined by the AP based on the quantity of receiving nodes that need to communicate; or the code may be a Zadoff-CHU sequence; or the code may further be any orthogonal sequence, a quasi-orthogonal sequence, a non-orthogonal sequence, any another sequence, or the like. FIG. 5E is a fourth schematic diagram of resource information. FIG. 5F is a fifth schematic diagram of resource information. As shown in FIG. 5E, one sub-channel is corresponding to one resource block, and the node that meets the preset condition may send the reply message on the corresponding resource block indicated by the AP. As shown in FIG. 5F, one code in one sub-channel (or one RU) is corresponding to one resource block, or different codes in the same sub-channel may be used as the resource information that distinguishes between nodes, and the node that meets the preset condition may send the reply message on the corresponding resource block indicated by the AP.

In one embodiment, the resource allocation indication information is located in any one of the following fields in the payload of the information frame: a common information field or a node information field. Certainly, the resource allocation indication information may further be located in another field, which is not limited in this embodiment.

FIG. 5G is a second schematic structural diagram of an information frame. As shown in FIG. 5G the information frame includes a MAC header, payload, and a frame detection sequence. Optionally, an address 1 in the MAC header includes an address of a receive end, an address 2 includes an address of a transmit end, and the payload of the information frame includes a common information field and a node information field (STA Information field). Optionally, resource allocation indication information is located in the common information field. A value of one bit in the common information field is corresponding to one RU. Consecutive equal values of bits in the common information field may indicate that consecutive RUs are allocated to a same receiving node, and a changed value of a bit may indicate that the receiving node to which the RU is allocated changes. For example, if the common information field may be 111001101, 111 in the common information field indicates that three consecutive RUs in one channel are allocated to one receiving node such as a STA 1, 00 in the common information field indicates that two subsequent consecutive RUs in the channel are allocated to another receiving node such as a STA 2, 11 in the common information field indicates that two subsequent consecutive RUs in the channel are allocated to still another receiving node such as a STA 3, 0 in the common information field indicates that one subsequent RU in the channel is allocated to yet another receiving node such as a STA 4, and 1 in the common information field indicates that one subsequent RU in the channel is allocated to yet another receiving node such as a STA 5. In the node information field, identifiers of the receiving nodes are sequentially indicated and respectively correspond to the allocated resources (that is, the identifiers of the receiving nodes may be successively receiving nodes corresponding to the allocated resources). Optionally, the identifier may be an AID or a PAID, and certainly, may alternatively be other identifier information. This is not limited in this embodiment.

In one embodiment, the resource allocation indication information is located in the node information field. A field corresponding to each receiving node in the node information field may include an identifier of each receiving node and a resource identifier corresponding to each receiving node. Optionally, the resource identifier corresponding to each receiving node may be an RU identifier or another resource identifier, and this is not limited in this embodiment. Optionally, the identifier may be the AID or the PAID, and certainly, may alternatively be other identifier information, and this is not limited in this embodiment.

Based on the foregoing embodiments, further, the AP generates the resource allocation indication information based on type information of the at least one STA.

Further, operation 102 includes: The AP receives the reply message that is sent by different types of STAs in the at least one STA based on the resource allocation indication information by using a time division multiplexing resource.

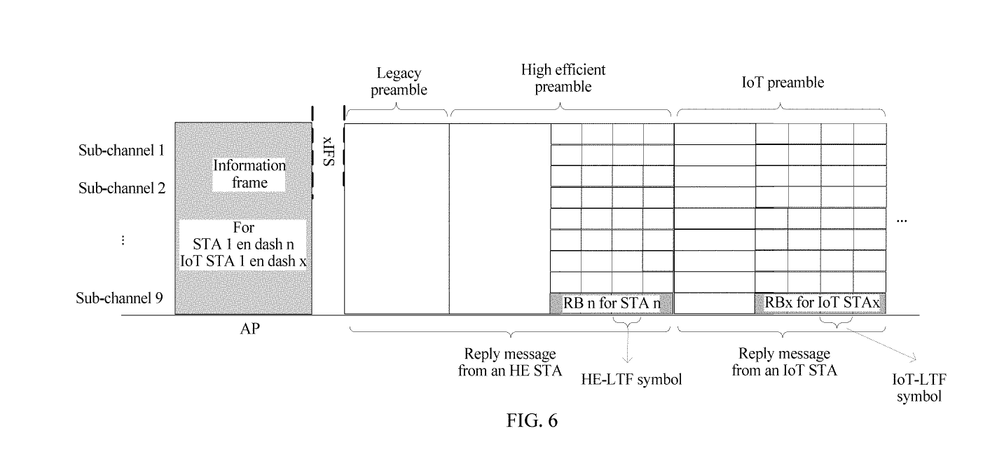

In this embodiment, the AP obtains the type information of the at least one STA. Optionally, the type information includes one of the following: an HE STA and an IoT STA, and the resource allocation indication information is separately generated for the two types of STAs based on the type information of the at least one STA, so that STAs of different types send the reply messages on a corresponding resource based on the resource allocation indication information. Optionally, the HE STA may send the reply message on the subunit information in the HE-LTF of the high efficient HE preamble, and/or the IoT STA may send the reply message on the subunit information in the IoT-LTF of the IoT preamble. Further, the AP receives the reply message that is sent by different types of STAs in the at least one STA based on the resource allocation indication information by using the time division multiplexing resource. As shown in FIG. 6 (FIG. 6 is a sixth schematic diagram of resource information), an HE STA that meets the preset condition may send the reply message on a corresponding resource block that is in the HE-LTF of the high efficient HE preamble and that is indicated by the AP, and/or an IoT STA that meets the preset condition may send the reply message on a corresponding resource block that is in the IoT-LTF of the IoT preamble and that is indicated by the AP.

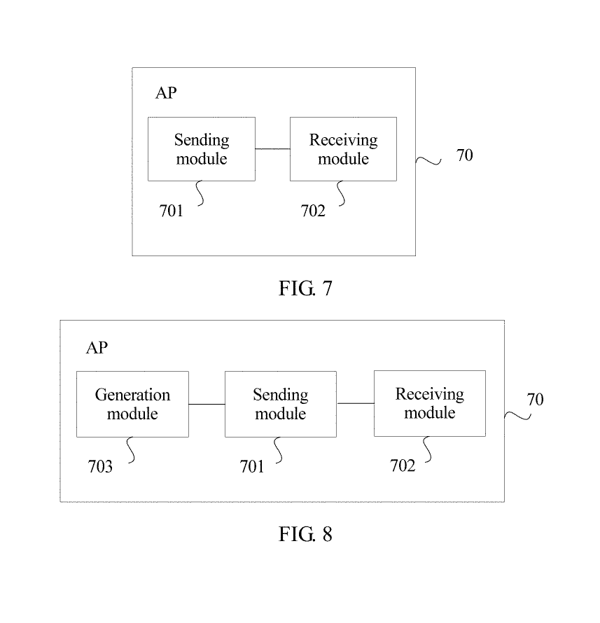

FIG. 7 is a schematic structural diagram of Embodiment 1 of an AP according to this application. As shown in FIG. 7, the AP 70 provided in this embodiment includes:

a sending module 701, configured to send relay indication information to at least one STA; and

a receiving module 702, configured to receive a reply message sent by one or more of the at least one STA.

Optionally, the relay indication information includes one or more of the following:

an indication about whether a relay STA is used for data transmission;

a quantity of relay STAs used for data transmission;

an identifier of the relay STA used for data transmission; or

an indication about whether a message sent by the relay STA carries a preamble.

In one embodiment, the sending module 701 is specifically configured to send an information frame to the at least one STA, where the information frame includes the relay indication information.

In one embodiment, the relay indication information is located in a preamble, a service domain, a MAC header, or payload of the information frame.

In one embodiment, the relay indication information is located in an unused or a reusable field of the preamble, the service domain, the MAC header, or the payload of the information frame; or

the relay indication information is located in a newly added indication field of the preamble, the service domain, the MAC header, or the payload of the information frame.

In one embodiment, the relay indication information is located in one of the following fields of the preamble: a field indicating a MCS, a field indicating a quantity of streams, or a field indicating bandwidth.

In one embodiment, the sending module 701 is specifically configured to send the relay indication information to the at least one STA in a first time period, where the relay indication information is forwarded by a relay STA in the at least one STA in a second time period to an Internet of Things STA within a management range of the relay STA.

In one embodiment, the receiving module 702 is specifically configured to:

when the Internet of Things STA belongs to the at least one STA, receive, in the second time period, the reply message sent by a STA in the at least one STA other than the relay STA and the Internet of Things STA; or

when the Internet of Things STA does not belong to the at least one STA, receive, in the second time period, the reply message sent by a STA in the at least one STA other than the relay STA.

In one embodiment, the receiving module 702 is further configured to receive acknowledgement information sent by the Internet of Things STA by using the relay STA, where the acknowledgement information is used to indicate, to the AP, that the Internet of Things STA can receive a frame sent by the AP.

In one embodiment, the information frame further includes relay condition information, where the relay condition information is used to indicate a preset condition for becoming the relay STA.

In one embodiment, the preset condition includes one or more of the following:

a link condition;

a STA service condition;

a power supply condition of the STA;

a quantity of other STAs within a preset range; or

a condition under which a target STA can be connected.

In one embodiment, the information frame further includes resource allocation indication information, and the resource allocation indication information is used to indicate, to the at least one STA, a resource used for sending the reply message.

In one embodiment, the resource allocation indication information is located in any one of the following fields in the payload of the information frame: a common information field or a node information field.

In one embodiment, based on the foregoing embodiment, as shown in FIG. 8 (FIG. 8 is a schematic structural diagram of Embodiment 2 of the AP according to this application), the AP further includes:

a generation module 703, configured to generate the resource allocation indication information based on type information of the at least one STA.

In one embodiment, the receiving module 702 is specifically configured to:

receive the reply message that is sent by different types of STAs in the at least one STA based on the resource allocation indication information by using a time division multiplexing resource.

In one embodiment, the resource information includes subunit information in a high efficient long training field HE-LTF in a high efficient HE preamble of the information frame, or subunit information in an Internet of Things long training field IoT-LTF in an Internet of Things IoT preamble of the information frame; where

the subunit information of the HE-LTF is corresponding to any one of the following: a sub-channel, the sub-channel and a time domain code, the sub-channel and a frequency domain code, or the sub-channel and a code; and

the subunit information of the IoT-LTF is corresponding to any one of the following: the sub-channel, the sub-channel and the time domain code, the sub-channel and the frequency domain code, or the sub-channel and the code.

The AP provided in this embodiment of this application may be configured to execute the technical solutions in any embodiment of the foregoing relay indication method in this application. Implementation principles and technical effects are similar, and details are not described herein again.

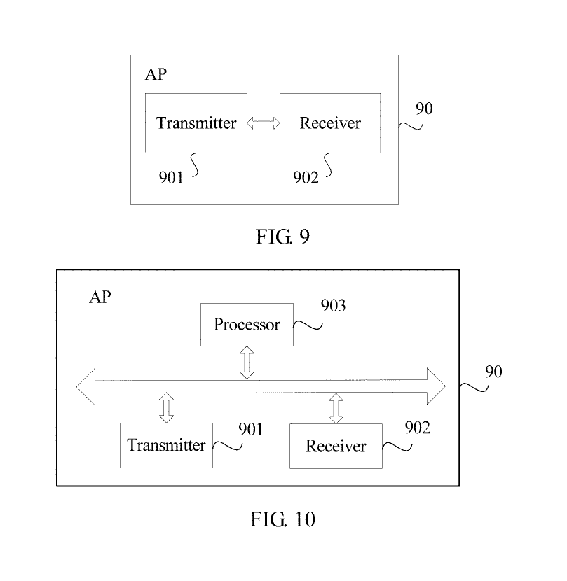

FIG. 9 is a schematic structural diagram of Embodiment 3 of an AP according to this application. As shown in FIG. 9, an AP 90 provided in this embodiment may include: a transmitter 901 and a receiver 902. The transmitter 901 is configured to send relay indication information to at least one STA. The receiver 902 is configured to receive a reply message sent by one or more of the at least one STA.

In one embodiment, the relay indication information includes one or more of the following:

an indication about whether a relay STA is used for data transmission;

a quantity of relay STAs used for data transmission;

an identifier of the relay STA used for data transmission; or

an indication about whether a message sent by the relay STA carries a preamble.

In one embodiment, the transmitter 901 is specifically configured to send an information frame to the at least one STA, where the information frame includes the relay indication information.

In one embodiment, the relay indication information is located in a preamble, a service domain, MAC header, or payload of the information frame.

In one embodiment, the relay indication information is located in an unused or a reusable field of the preamble, the service domain, the MAC header, or the payload of the information frame; or

the relay indication information is located in a newly added indication field of the preamble, the service domain, the MAC header, or the payload of the information frame.

In one embodiment, the relay indication information is located in one of the following fields of the preamble: a field indicating a modulation and coding scheme MCS, a field indicating a quantity of streams, or a field indicating bandwidth.

In one embodiment, the transmitter 901 is specifically configured to send the relay indication information to the at least one STA in a first time period, where the relay indication information is forwarded by a relay STA in the at least one STA in a second time period to an Internet of Things STA within a management range of the relay STA.

In one embodiment, the receiver 902 is specifically configured to:

when the Internet of Things STA belongs to the at least one STA, receive, in the second time period, the reply message sent by a STA in the at least one STA other than the relay STA and the Internet of Things STA; or
when the Internet of Things STA does not belong to the at least one STA, receive, in the second time period, the reply message sent by a STA in the at least one STA other than the relay STA.

In one embodiment, the receiver 902 is further configured to receive acknowledgement information sent by the Internet of Things STA by using the relay STA, where the acknowledgement information is used to indicate, to the AP, that the Internet of Things STA can receive a frame sent by the AP.

In one embodiment, the information frame further includes relay condition information, where the relay condition information is used to indicate a preset condition for becoming the relay STA.

In one embodiment, the preset condition includes one or more of the following:

a link condition;

a STA service condition;

a power supply condition of the STA;

a quantity of other STAs within a preset range; or

a condition under which a target STA can be connected.

In one embodiment, the information frame further includes resource allocation indication information, and the resource allocation indication information is used to indicate, to the at least one STA, a resource used for sending the reply message.

In one embodiment, the resource allocation indication information is located in any one of the following fields in the payload of the information frame: a common information field or a node information field.

In one embodiment, based on the foregoing embodiment, as shown in FIG. 10 (FIG. 10 is a schematic structural diagram of Embodiment 4 of the AP according to this application), the AP further includes:

a processor 903, configured to generate the resource allocation indication information based on type information of the at least one STA.

In one embodiment, the receiver 902 is specifically configured to:

receive the reply message that is sent by different types of STAs in the at least one STA based on the resource allocation indication information by using a time division multiplexing resource.

In one embodiment, the resource information includes subunit information in a high efficient long training field HE-LTF in a high efficient HE preamble of the information frame, or subunit information in an Internet of Things long training field IoT-LTF in an Internet of Things IoT preamble of the information frame; where

the subunit information of the HE-LTF is corresponding to any one of the following: a sub-channel, the sub-channel and a time domain code, the sub-channel and a frequency domain code, or the sub-channel and a code; and

the subunit information of the IoT-LTF is corresponding to any one of the following: the sub-channel, the sub-channel and the time domain code, the sub-channel and the frequency domain code, or the sub-channel and the code.

The AP provided in this embodiment of this application may be configured to execute the technical solutions in any embodiment of the foregoing relay indication method in this application. Implementation principles and technical effects are similar, and details are not described herein again.

In the several embodiments provided in this application, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) or a processor to perform some of the operations of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

It may be clearly understood by a person skilled in the art that, for the purpose of convenient and brief description, division of the foregoing function modules is taken as an example for illustration. In actual application, the foregoing functions can be allocated to different function modules and implemented according to a requirement, that is, an inner structure of an apparatus is divided into different function modules to implement all or some of the functions described above. For a detailed working process of the foregoing described apparatus, reference may be made to a corresponding process in the foregoing method embodiments, and details are not described herein.

A person skilled in the art may understand that sequence numbers of the foregoing processes do not mean execution sequences in various embodiments of this application. The execution sequences of the processes should be determined according to functions and internal logic of the processes, and should not be construed as any limitation on the implementation processes of the embodiments of this application.

What is claimed is:

1. An apparatus, applied in access point (AP) side, comprising:
a transmitter; and
a receiver;
wherein the transmitter is configured to send an information frame to at least one station (STA), wherein the information frame comprises the relay indication information; and
wherein the receiver is configured to receive a reply message sent by one or more of the at least one STA.

2. The apparatus according to claim 1, wherein the relay indication information comprises one or more of the following:
an indication about whether a relay station (STA) is used for data transmission;
a quantity of relay STAs used for data transmission;
an identifier of the relay STA used for data transmission; or
an indication about whether a message sent by the relay STA carries a preamble.

3. The apparatus according to claim 1, wherein the relay indication information is located in one of the following: a preamble of the information frame, a service domain of the information frame, a Media Access Control (MAC) header of the information frame, or a payload of the information frame.

4. The apparatus according to claim 3, wherein the relay indication information is located in an newly added indication field, an unused field, or a reusable field of one of the following: the preamble of the information frame, the service domain of the information frame, the MAC header of the information frame, or the payload of the information frame.

5. The apparatus according to claim 3, wherein the relay indication information is located in one of the following fields of the preamble: a field indicating a modulation and coding scheme (MCS), a field indicating a quantity of streams, or a field indicating bandwidth.

6. The apparatus according to claim 1, wherein the transmitter is configured to send the information frame to the at least one STA in a first time period, and wherein the information frame is forwarded by a relay STA in the at least one STA in a second time period to an Internet of Things STA within a management range of the relay STA.

7. The apparatus according to claim 6, wherein the receiver is configured to:
when the Internet of Things STA belongs to the at least one STA, receive, in the second time period, the reply message sent by a STA in the at least one STA other than the relay STA and the Internet of Things STA; or
when the Internet of Things STA does not belong to the at least one STA, receive, in the second time period, the reply message sent by a STA in the at least one STA other than the relay STA.

8. The apparatus according to claim 6, wherein the receiver is further configured to receive acknowledgement information sent by the Internet of Things STA by using the relay STA, and wherein the acknowledgement information is used to indicate, to the AP, that the Internet of Things STA can receive a frame sent by the AP.

9. The apparatus according to claim 1, wherein the information frame further comprises relay condition information, and wherein the relay condition information is used to indicate a preset condition for becoming the relay STA.

10. The apparatus according to claim 9, wherein the preset condition comprises one or more of the following:
a link condition;
a STA service condition;
a power supply condition of the STA;
a quantity of other STAs within a preset range; or
a condition under which a target STA can be connected.

11. An apparatus, applied in station side, comprising:
a transmitter; and
a receiver;
wherein the receiver is configured to receive an information frame, wherein the information frame comprises the relay indication information; and
wherein the transmitter is configured to send a reply message.

12. The apparatus according to claim 11, wherein the relay indication information comprises one or more of the following:
an indication about whether a relay station (STA) is used for data transmission;
a quantity of relay STAs used for data transmission;
an identifier of the relay STA used for data transmission; or
an indication about whether a message sent by the relay STA carries a preamble.

13. The apparatus according to claim 1, wherein the relay indication information is located in one of the following: a preamble of the information frame, a service domain of the information frame, a Media Access Control (MAC) header of the information frame, or a payload of the information frame.

14. The apparatus according to claim 13, wherein the relay indication information is located in an newly added indication field, an unused field, or a reusable field of one of the following: the preamble of the information frame, the service domain of the information frame, the MAC header of the information frame, or the payload of the information frame.

15. The apparatus according to claim 13, wherein the relay indication information is located in one of the following fields of the preamble: a field indicating a modulation and coding scheme (MCS), a field indicating a quantity of streams, or a field indicating bandwidth.

16. The apparatus according to claim 11, wherein the receiver is configured to receive the information frame in a first time period, and wherein the transmitter of a relay STA in the apparatus is further configured to forward the information frame to an Internet of Things STA within a management range of the relay STA in a second time period.

17. The apparatus according to claim 16, wherein
when the Internet of Things STA belongs to the at least one apparatus, an apparatus in the at least one apparatus other than the relay STA and the Internet of Things STA send the reply message in the second time period; or
when the Internet of Things STA does not belong to the at least one apparatus, an apparatus in the at least one apparatus other than the relay STA send the reply message in the second time period.

18. The apparatus according to claim 11, wherein the information frame further comprises relay condition information, and wherein the relay condition information is used to indicate a preset condition for becoming the relay STA.

19. The apparatus according to claim 18, wherein the preset condition comprises one or more of the following:
a link condition;
a STA service condition;
a power supply condition of the STA;
a quantity of other STAs within a preset range; or
a condition under which a target STA can be connected.
